(19) United States
(12) Patent Application Publication
(10) Pub. No.: US 2020/0076070 A1
(43) Pub. Date: Mar. 5, 2020

(54) HIGH-DIRECTIVITY BROADBAND SIMULTANEOUS TRANSMIT AND RECEIVE (STAR) ANTENNA AND SYSTEM

(71) Applicant: The Regents of the University of Colorado, a body, Denver, CO (US)

(72) Inventors: Dejan S. Filipovic, Lafayette, CO (US); Prathap Valale Valaleprasannakumar, Boulder, CO (US); Mohamed Ali Elmansouri, Boulder, CO (US)

(21) Appl. No.: 16/370,881

(22) Filed: Mar. 29, 2019

Related U.S. Application Data
(60) Provisional application No. 62/650,159, filed on Mar. 29, 2018.

(51) Int. Cl. H01Q 1/52; H01Q 19/12; H01Q 1/24

(52) U.S. Cl. CPC H01Q 1/521; H01Q 1/24; H01Q 19/12

(57) ABSTRACT

In various implementations, a quasi-monostatic STAR antenna system comprises a parabolic reflector antenna for transmission (TX) and a receiving (RX) antenna mounted back-to-back with the reflector feed. The physical size of the RX antenna can be comparable to or smaller than that of the TX feed, in order to prevent additional reflector blockage. To increase the system isolation both the TX feed and the RX antenna are CP. In one implementation, for example, to achieve same TX and RX polarization (i.e. no polarization multiplexing) the TX feed is LHCP and the RX antenna is RHCP. The LHCP fields from the TX feed undergo polarization reversal after bouncing back from the reflector. Thereby, the TX and RX operate in the same polarization, as illustrated in FIG. 1. This approach can also support simultaneous dual polarized operation if appropriate feed and RX antenna are used

### CROSS-REFERENCE TO RELATED APPLICATIONS

This application claims the benefit of U.S. provisional application No. 62/650,159, filed Mar. 29, 2018, which is hereby incorporated by reference as though fully set forth herein.

### GOVERNMENT LICENSE RIGHTS

This invention was made with government support under Award No. W911NF-17-1-0228 awarded by the U.S. Army Research Office, and N00014-15-1-2125 awarded by the Office of Naval Research. The government has certain rights in the invention.

### BACKGROUND

### a. Field

The instant disclosure relates to simultaneous transmit and receiver (STAR) antennas.

### b. Background

A simultaneous transmit and receive (STAR) antenna system or in-band full-duplex system has the potential to double the throughput of a communication channel and may find application in systems such as next-generation wireless networks. Similarly, these systems could increase the effectiveness of EW and S operation, by facilitating spectrum/channel sensing while jamming. A self-interference (SI) phenomenon, where the transmitter disrupts its own receiver is a major challenge in the practical realization of STAR systems. High isolation (>130 dB) is often required to overcome this SI. The required isolation is typically achieved through cancellation levels such as antenna, analog, digital and signal processing layers. Implementations provided are adapted to increase the isolation at the antenna layer. This can be attained by employing bi-static, monostatic, and quasi-monostatic architectures.

### BRIEF SUMMARY

In various implementations, a quasi-monostatic STAR antenna and antenna system are provided. In some implementations, for example, the antennas and antenna systems provide improved isolation, (e.g., >30 dB in average over the existing high gain monostatic STAR configurations). The approach can also be resilient to asymmetries and imbalances in antenna geometry and in beam forming network (BFN) components. In some implementations utilizing circular polarity (CP), antenna systems can demonstrate measured average isolation 61 dB with the COTS components having ±0.5 dB and ±3°, ±0.6 dB and ±10° for 90° hybrids and 180°, respectively. Also, in some example implementations, quasi-monostatic STAR antennas and antenna systems can facilitate, simultaneously, linearly co-polarized transmission and reception with isolation >40 dB, and gain >20 dBi (for TX antenna) while retaining the overall system's physical footprint (in xy-plane) of a transmitting antenna alone.

The foregoing and other aspects, features, details, utilities, and advantages of the present invention will be apparent from reading the following description and claims, and from reviewing the accompanying drawings.

### BRIEF DESCRIPTION OF THE DRAWINGS

FIGS. 1A and 1B show a schematic drawing of an example implementation of a quasi-monostatic antenna.

FIGS. 2A and 2B show a schematic drawing of an example implementation of a quasi-monostatic antenna.

FIGS. 3A and 3B show example coaxial cavity antennas mounted back-to-back.

FIG. 4 is a graph showing simulated mutual coupling between the TX and RX ports of the coaxial cavity antennas.

FIG. 5 is a graph showing simulated isolation between TX and RX for linear polarization and separation distance of 13 cm.

FIG. 6 is a graph showing simulated F/B of coaxial cavity antenna for linear polarization.

FIG. 7 is a graph showing simulated isolation between linearly polarized antennas mounted back-to-back at separation distances of 13 and 27 cm.

FIG. 8 is a graph showing Isolation between coaxial cavity antennas (RX and TX feeds) connected back-to-back when operated in CP.

FIGS. 9A and 9B show simulations of the radiation patterns for linear and circular polarization at 4, 6, and 8 GHz (FIG. 9A), and front/back (F/B) of a coaxial cavity antenna (FIG. 9B).

FIG. 10 is a graph showing simulated mutual coupling between the TX and RX ports of the antennas with and without a reflector.

FIG. 11 is a graph showing simulated system isolation with reflector.

FIGS. 12A and 12B are graphs showing Transient analysis (in CST) of coaxial cavity antennas (RX and TX feed) mounted back-to-back with and without reflector, in FIG. 12A co-pol to co-pol, and in FIG. 12B co-pol to cross-pol.

FIG. 13 is a graph showing measured and simulated system isolation of the proposed quasi-monostatic reflector STAR antenna.

FIG. 14 is a graph showing a comparison of simulated system isolation with and without reflector surface roughness.

FIG. 15 is a graph showing measured and simulated VSWR of the RX antenna with and without reflector.

FIG. 16 is a graph showing measured and simulated gain of the RX antenna with and without reflector.

FIG. 17 shows measured and simulated radiation patterns of the RX antenna without reflector.

FIG. 18 shows measured and simulated radiation patterns of the RX antenna with reflector.

FIG. 19 is a graph showing simulated and measured gain, and VSWR of the TX antenna.

FIG. 20 is a graph showing measured and simulated radiation patterns of the TX.

FIG. 21 graphically shows Simulated reflector co-polarized radiation patterns for θ=0° and 45° (a) without, and (b) with struts.

FIGS. 22A and 22B show a simulated radiation pattern, and front-to-back ratio of a coaxial cavity antenna with and without corrugations, and when recessed in an absorber.

FIGS. 23A and 23B show Simulated isolation between the antennas with and without corrugations for the ideal and measured BFN, (a) without reflector, and (b) with reflector.

FIG. 24 shows CAD models of cavity backed spiral, and an example back-to-back spiral with reflector.

FIG. 25 is a graph showing measured system isolation of the quasi-monostatic STAR with cavity backed spiral.

FIG. 26 graphically shows simulated radiation pattern of a cavity backed spiral.

FIG. 27 is a graph showing atmospheric attenuation of microwave at sea level.

FIGS. 28A, 28B and 28C show CAD models of example STAR antenna configurations.

FIG. 29 shows a Cassegrain reflector with design variables.

FIG. 30 is a graph showing simulated directivity of a Cassegrain reflector at 3.9 GHz.

FIG. 31 shows a diagram of a dual reflector with feed locations and a corresponding sub-reflector position and a flow chart explaining design steps.

FIG. 32 is a graph showing gain of a dual reflector with and without sub-reflector blockage.

FIG. 33 is a graph showing simulated isolation of a dual reflector for linear and circular polarizations.

FIG. 34 shows a model of a dual reflector with an array, a sub-reflector top view and an 8×8 Vivaldi array.

FIG. 35 includes graphs showing a simulated isolation of a dual reflector STAR with an array and radiation patterns of an 8×8 Vivaldi array.

FIG. 36 shows a CAD model of a quad ridge waveguide, a QRH aperture and a QRH.

FIG. 37 is a graph showing simulated co- and cross-polarized gain of a TX feed.

FIG. 38 is a graph showing simulated gain versus frequency of a TX feed.

FIG. 39 is a graph showing normalized radiation patterns of a TX feed at ϕ°).

FIGS. 40A, 40B, 40C, 40D and 40E are graphs showing simulated radiation patterns of dual reflectors.

FIG. 41 is a graph showing a simulated gain of a dual reflector symmetric with a Gaussian beam and QRH.

FIG. 42 is a graph showing simulated gain of QRH with a dual reflector.

FIG. 43 shows simulated surface current distribution of a dual reflector.

FIG. 44 shows CAD models of a dual reflector and side and bottom views of a modified and regular sub-reflector, respectively.

FIG. 45 shows simulated surface current distribution of a dual reflector with modified and regular hyperbolas.

FIG. 46 is a graph showing simulated gain of a dual reflector with an ideal feed, modified and regular hyperbola fed by QRH.

FIG. 47 is a graph showing simulated gain of a QRH with a modified dual reflector.

FIG. 48 shows CAD models of a quad ridge waveguide with a RX QRH aperture and a RX QRH.

FIG. 49 is a graph showing simulated gain of a RX QRH without a lens.

FIG. 50 is a graph showing simulated gain of an RX without a lens and a TX (dual reflector).

FIG. 51 shows CAD models of a dual surface lens and RX QRH with a lens.

FIG. 52 is a graph showing simulated gain of a TX, RX with and without a lens.

FIG. 53 is a graph showing simulated gain of a RX QRH with and without a lens, and a fed turnstile junction.

FIG. 54 is a graph showing simulated co- and cross-pol radiation patterns of an RX with a lens.

FIG. 55 is a graph showing simulated isolation of a system with and without metallic struts.

FIG. 56 is a graph showing simulated isolation of a system with frequency independent electrical imbalances.

FIG. 57 is a graph showing simulated isolation of a system with mechanical asymmetries.

FIG. 58 is a graph showing isolation with and without a reflector.

FIG. 59 is a graph showing simulated and measured gain.

FIG. 60 is a graph showing measured isolation versus frequency for antennas with commercial off-the-shelf (COTS) components and ideal hybrid components.

### DETAILED DESCRIPTION

Various implementations of wideband simultaneous transmit and receive (STAR) antenna systems are provided. Implementations of a STAR antenna system adapted to increase isolation at the antenna layer are provided. In various implementations, this can be attained by employing bi-static, monostatic, and quasi-monostatic architectures.

Bi-static configurations use separate TX and RX antennas. Hence, the SI can be minimized by separating the apertures, embedding high impedance surfaces (HISs), or by recessing the RX antenna inside the absorber, as demonstrated in this thesis. The advantages and limitations of each of these techniques can be analyzed through full-wave simulations and measurements. High power capable, wideband, metallic quad ridge horn (QRH) antennas can realize a bi-static, dual polarized STAR system. Bi-static configurations are robust and less sensitive to the imbalances. However, they require significant area. When a bi-static approach is applied to reflector-based systems, it further increases the overall size of the system. Additionally, increasing the number of individual antennas enhances the overall RCS of the platform which is undesirable. Hence, a monostatic STAR configuration can be beneficial for a high gain system.

In one example of a monostatic STAR configuration, for example, a monostatic STAR antenna configuration may be adapted to operate from 4-8 GHz by feeding a circularly polarized (CP) reflector antenna with an all-analog beamforming network (BFN) comprising two 90° and 180° hybrids and two circulators. The BFN can be arranged to cancel the coupled/leaked signal from the antenna and circulators, by creating 180° phase difference between the TX and RX reflected signals. Theoretically, the approach can provide high isolation. However, it is limited by the electrical and geometrical imbalances. Nonetheless, using COTS components with noticeable imbalances, isolation greater than that obtained with a conventional circulator approach. Quasi-Monostatic STAR

In some implementations, a quasi-monostatic STAR approach addresses the limitations of bi-static and monostatic configurations. In one implementation, for example, a configuration can achieve 30 dB (on average) higher isolation than the monostatic reflector architecture with the same BFN components. The quasi-monostatic STAR antenna system comprises a parabolic reflector antenna for transmission, and a receiving antenna mounted back-to-back with the reflector feed. To increase the system isolation both the TX feed and the RX antenna are circularly polarized (CP). Further, in this implementation, to achieve the same TX and RX polarization the TX feed can be LHCP, and the RX antenna can be RHCP. The LHCP fields from the TX feed undergo polarization reversal after bouncing back from the reflector. Thereby, the TX and RX operate in the same polarization. The approach is less sensitive to the BFN imbalances and geometrical asymmetries. In one example, an average measured isolation of 61 dB is obtained using COTS components with relatively-high amplitude and phase imbalances. Further, the same concept can be extended to mm-Wave (18-45 GHz), where a dual reflector antenna with the RX mounted behind the unused area of secondary-reflector is employed to achieve STAR operations.

In some applications, a monostatic configuration is a preferred approach for high gain, long-range, in-band full-duplex systems. In one particular example implementation, a proposed configuration can achieve 30 dB (on average) higher isolation than the approach in with the same BFN components. The quasi-monostatic STAR configuration can facilitate, simultaneously, linearly co-polarized transmission and reception with isolation >40 dB, and gain >20 dBi (for TX antenna) while retaining the overall system's physical footprint (in xy-plane) of a transmitting antenna alone. Techniques to enhance the antennas front-to-back (F/B) ratio and thereby, further improve the system isolation are also provided. Further, in some implementations, to address bandwidth extension to more than an octave, a wideband spiral antenna can be employed for the feed and RX and high isolation can be achieved.

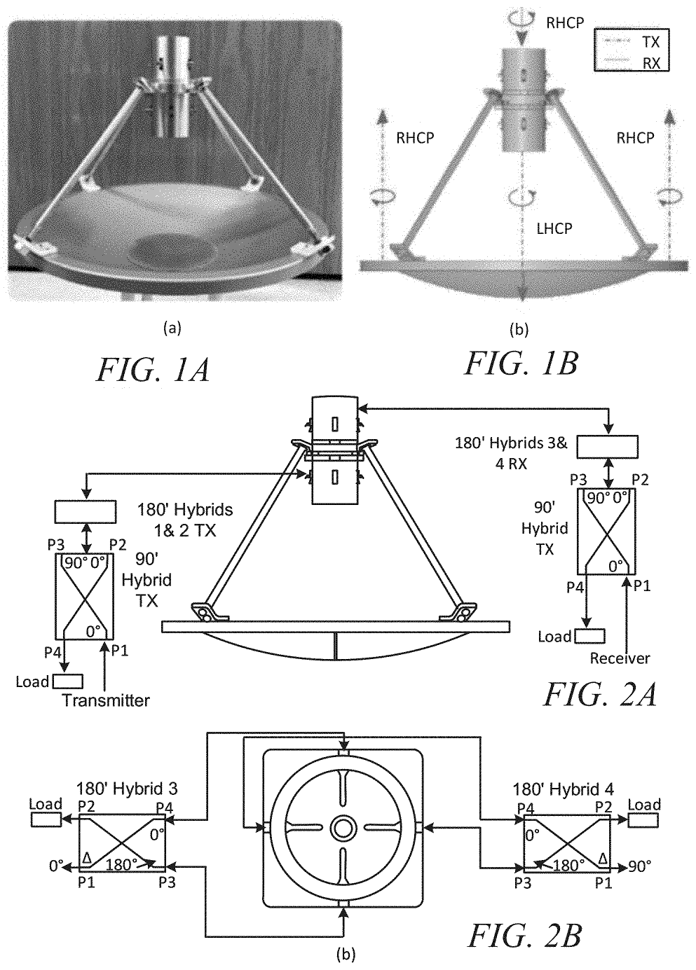

In one implementation, the system comprises a center fed axis symmetric parabolic reflector (such as, but not limited to those described in G. Poulton and T. Bird, “Improved rear-radiating waveguide cup feeds,” in 1986 Antennas and Propagation Society International Symposium, vol. 24. IEEE, 1986, pp. 79-82, 84, 95, incorporated by reference herein) for TX operation and a coaxial cavity antenna (such as, but not limited to, those described in T. Holzheimer, “Applications of the coaxial cavity antenna in time and frequency,” in 2004 Antenna Applications Symposium, 2004, pp. 1-19, 58, 60, 61, 84, 95, incorporated by reference herein) mounted above the feed for RX. An example implementation of the resulting configuration is shown in FIGS. 1A and 1B. The presence of the RX within the volume occupied by the TX helps reduce the system's physical size, analogous to a monostatic case. Further, in a baseline operational concept both the TX feed and the RX antenna can be circularly polarized. That is, (to achieve true-co-pol STAR) the former is left-hand CP (LHCP) whereas the latter is RHCP (or vice versa—TX RHCP and RX LHCP). The physical orientation of the antennas and the presence of the metallic reflector in this implementation leads to the same polarization operation for the TX and RX (see FIG. 1B). The system isolation is related to the front-to-back ratio (F/B), and the cross-polarization levels of the two back-to-back antennas. The polarization diversity between the two antennas provides additional cancellation layer, resulting in high system isolation. Additionally, due to the inherent low mutual coupling between the TX and RX feeds, the approach is less sensitive to the BFN imbalances and geometrical asymmetries. In one example, an average measured isolation of 61 dB is obtained using commercial off-the-self (COTS) components with relatively-high amplitude and phase imbalances.

As shown in FIGS. 1A and 1B, an example implementation of a quasi-monostatic STAR antenna system can comprise a parabolic reflector antenna for transmission and a receiving antenna mounted back-to-back with the reflector feed. In this implementation, the physical size of the RX antenna is comparable to or smaller than that of the TX feed, in order to prevent additional reflector blockage. To increase the system isolation both the TX feed and the RX antenna are CP. To achieve same TX and RX polarization (i.e. no polarization multiplexing) the TX feed can be LHCP and the RX antenna can be RHCP (or vice versa—TX RHCP and RX LHCP). The LHCP fields from the TX feed undergo polarization reversal after bouncing back from the reflector. Thereby, the TX and RX operate in the same polarization, as illustrated in FIG. 1B. This approach can also support simultaneous dual polarized operation if appropriate feed and RX antenna are used.

In this particular implementation, a dual-polarized coaxial cavity antenna can be used as a reflector feed and RX antenna. The antenna is selected due to its stable phase center, symmetric radiation patterns, and high radiation efficiency over the desired bandwidth of operation. The CP can be realized by implementing the antenna using 2×4 Butler matrix BFN including a 90° hybrid and two 180° hybrids (see FIG. 2).

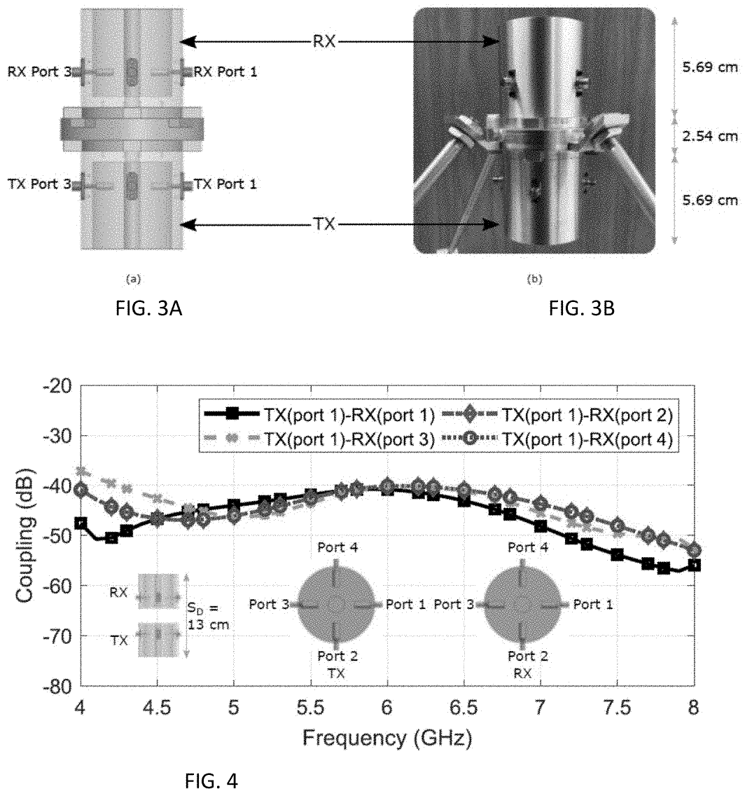

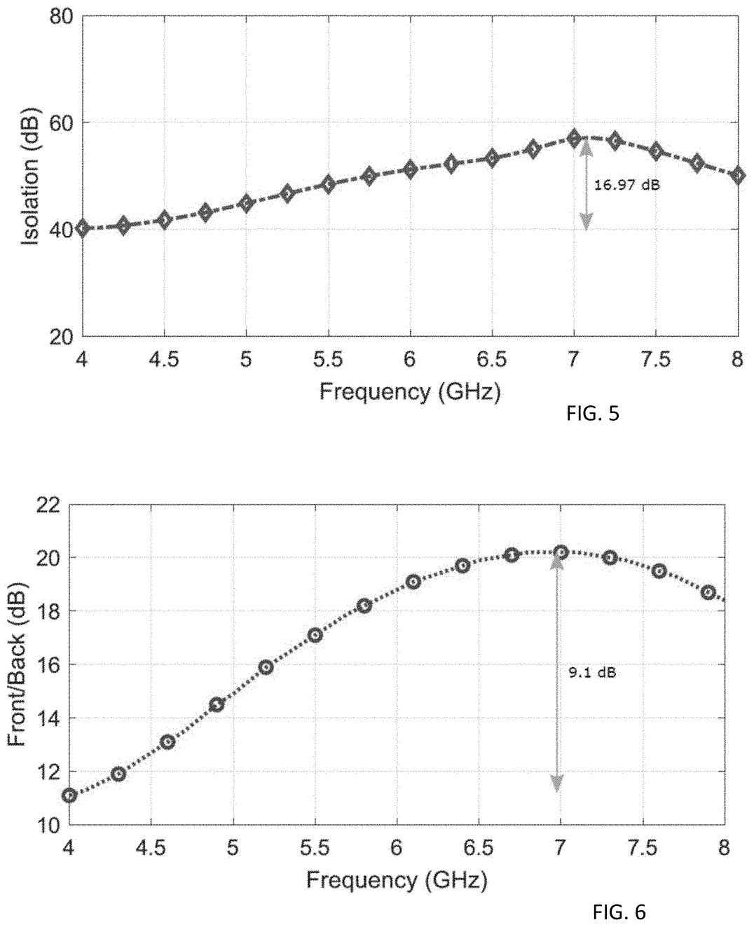

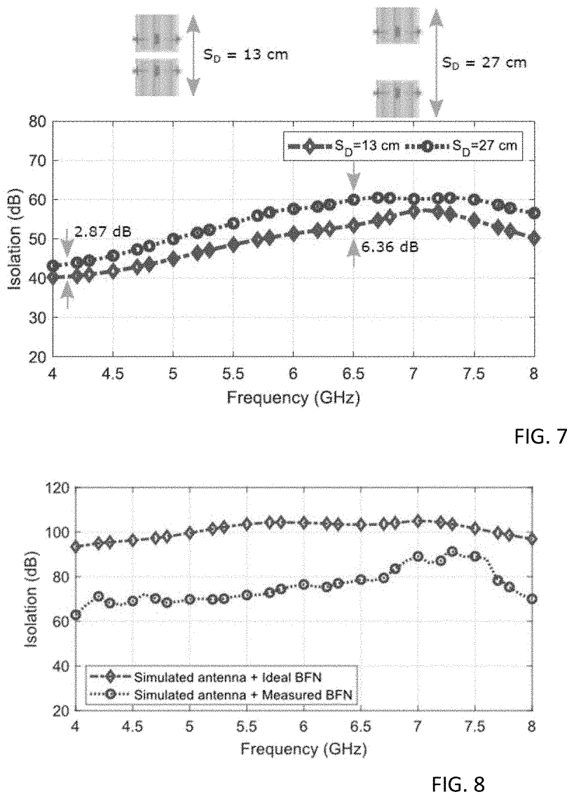

When the back-to-back antennas are in the far-field of each other, the coupling is through the back lobes. To save the space and easy mechanical integration, the TX feed and RX antenna can be arranged as in FIG. 3. Coupling mechanisms include currents on the sides of the antennas and the antenna's near field. Rather than separating the individual contributions to the overall coupling, the aggregate effect can be readily simulated. The coupling between the individual exciting probes (ports) is on the order of −40 dB in this implementation as shown in the FIG. 4. Similarly, the isolation between the linearly polarized (LP) antennas is >40 dB (see, e.g., FIG. 5). The increase in isolation with frequency is well correlated with the higher F/B, as shown in FIG. 6. Separating the antennas further away is one simple approach to enhance the isolation. For example, doubling the separation between antenna apertures enhances isolation by 6.36 dB (maximum), as shown in FIG. 7. However, this enlarges the overall system size. Placing an absorber between the two antennas can also improve isolation, at the expense of higher complexity.

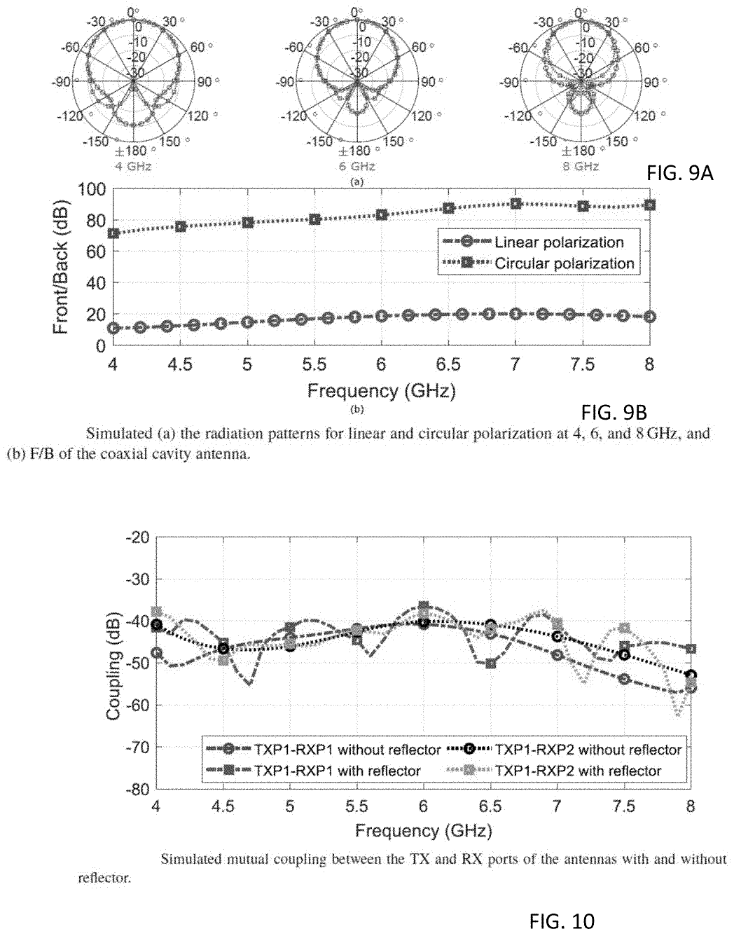

Contrarily, the isolation of the system can be enhanced (e.g., to >60 dB), such as shown in FIG. 8, by operating the antennas in CP. This increase in system isolation with the CP is due to the additional layer of signal cancellation from the polarization diversity, and due to the higher F/B of the antennas in comparison to the linear polarization, as shown in the FIG. 9. The S-parameters of the simulated antenna along with ideal BFN can be used in a circuit simulator (AWR microwave office) to obtain the results in FIG. 8. The isolation of the system is dependent on the imbalances and symmetry in the BFN and antenna geometry, respectively. Hence, imbalances in amplitude and phase of the COTS components can deteriorate the isolation of the system, which is shown in FIG. 5.8. The measured S-parameters of the COTS 90° hybrids, and 180° hybrids with amplitude and phase imbalances ±0.5 dB and ±3°, ±0.6 dB and ±10°, respectively are used in this particular example.

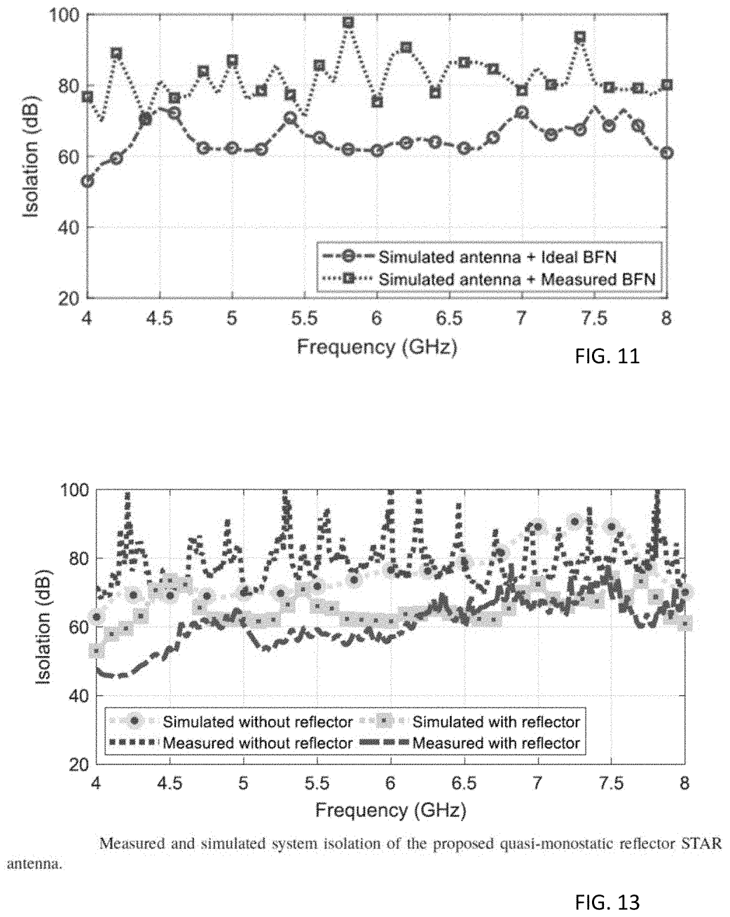

When the antennas are integrated with a reflector, the reflected fields from the parabolic surface provide two additional coupling paths. Specifically, in the path I, the reflected LHCP fields from the reflector will couple to the LHCP fields (co-pol) of the RX. Similarly, in path II, the cross-pol of the feed (LHCP) is radiated as RHCP (cross-pol) from the reflector resulting in coupling to the RHCP fields (cross-pol) of the RX. The influence of the additional paths can be inferred from the ripples (or standing waves) in the mutual coupling between ports with reflector, as illustrated in FIG. 10. These additional paths will also deteriorate the system isolation as shown in FIG. 11. Nevertheless, the impact of asymmetries on system isolation can be significantly reduced in comparison to other systems, and in one example >60 dB can be achieved. This makes this implementation of a quasi-monostatic configuration more robust towards imbalances. Importantly, at higher frequencies, the system isolation is even less sensitive because of the higher F/B and lower mutual coupling, which is an added benefit of the system.

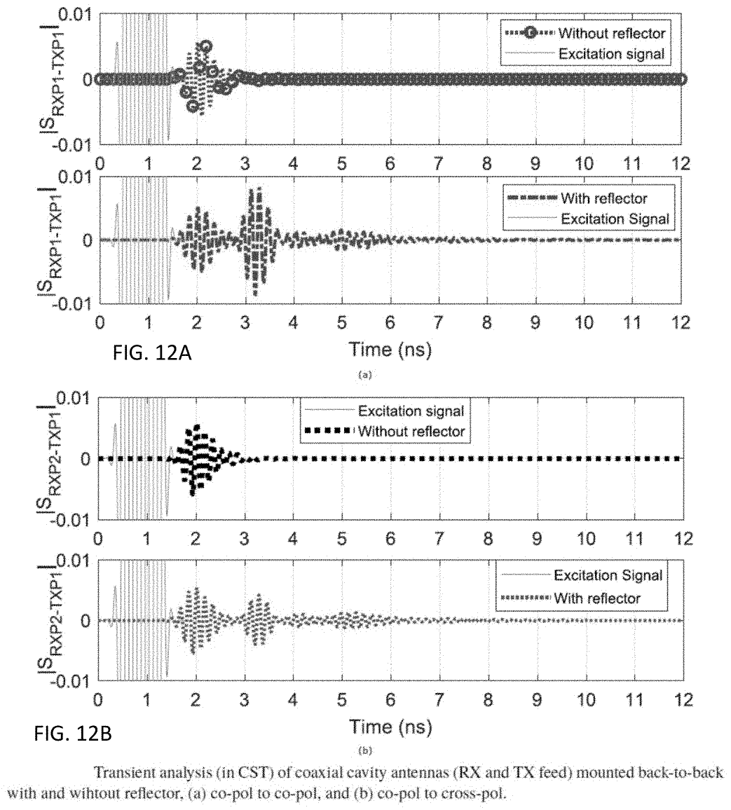

Further insight on the coupling mechanism of this implementation of an architecture can be obtained by analyzing the problem in the time domain. In this analysis, a transient pulse of 1 ns duration is transmitted from the feed (see FIGS. 12A and 12B). The signal coupled to the co-polarized port (RX-Port1) from the transmitting port (TX-Port 1) with and without reflector is shown in FIG. 12A, where the second signal pulse with higher amplitude highlights the importance of coupling through co-pol. Similarly, an additional signal pulse of lower magnitude in the signal coupled from TX-port 1 (co-pol) to RX-port 2 (cross-pol), in FIG. 12B, affirms the coupling through the cross-pol, in the presence of the reflector. The time domain analysis is carried out in a CST transient solver.

The measured system isolation in example implementations with and without a reflector is shown in FIG. 13. Some degradation in the system isolation can be observed from the measured results in comparison to the simulation. This degradation is mainly due to the small asymmetries in the fabricated antenna geometry inclusive of mounting. Nonetheless, the system in this example has an average high isolation of 61 dB. Most importantly, the isolation in this implementation is less sensitive to the imbalances.

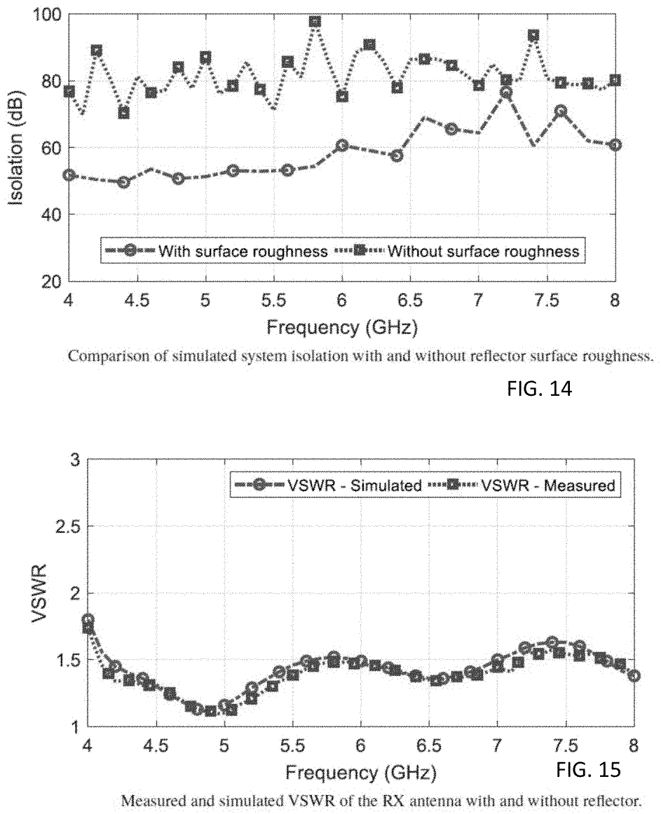

The roughness and deformations in a reflector surface can lead to asymmetries and may deteriorate system isolation. They can also negatively affect far-field performance. Hence, random roughness is modeled as Gaussian distribution with correlation length 10 cm (1.33λ_{4GHz}) and root mean square (RMS) height of 0.2 cm (0.026λ_{4GHz}). The asymmetries due to surface roughness have tolerable impact on system isolation in the proposed quasi-monostatic system, as shown in FIG. 14, therefore further highlighting the robustness towards asymmetries.

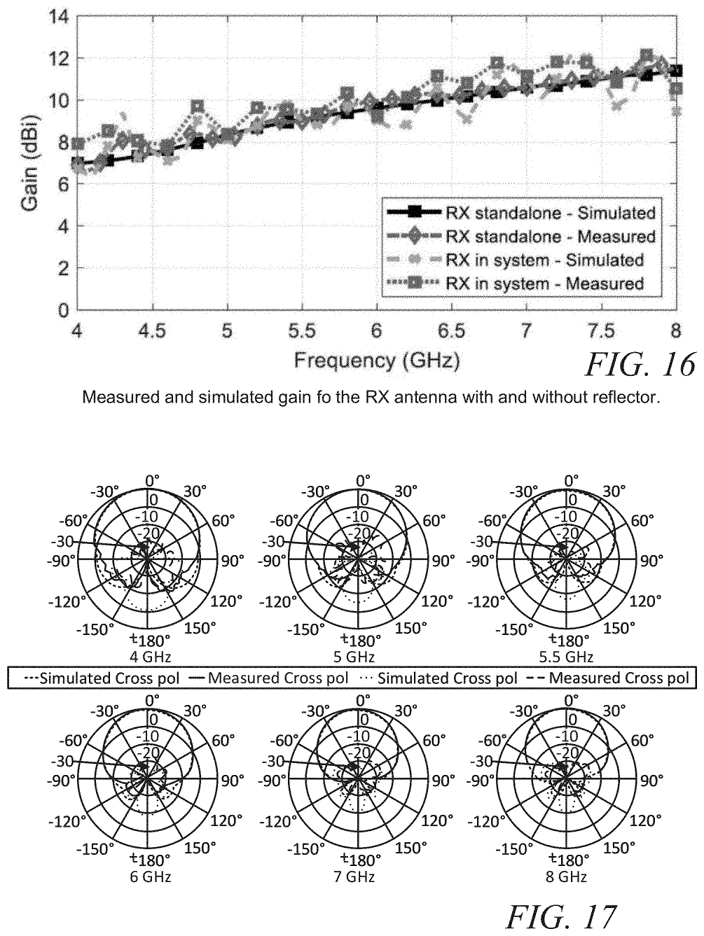

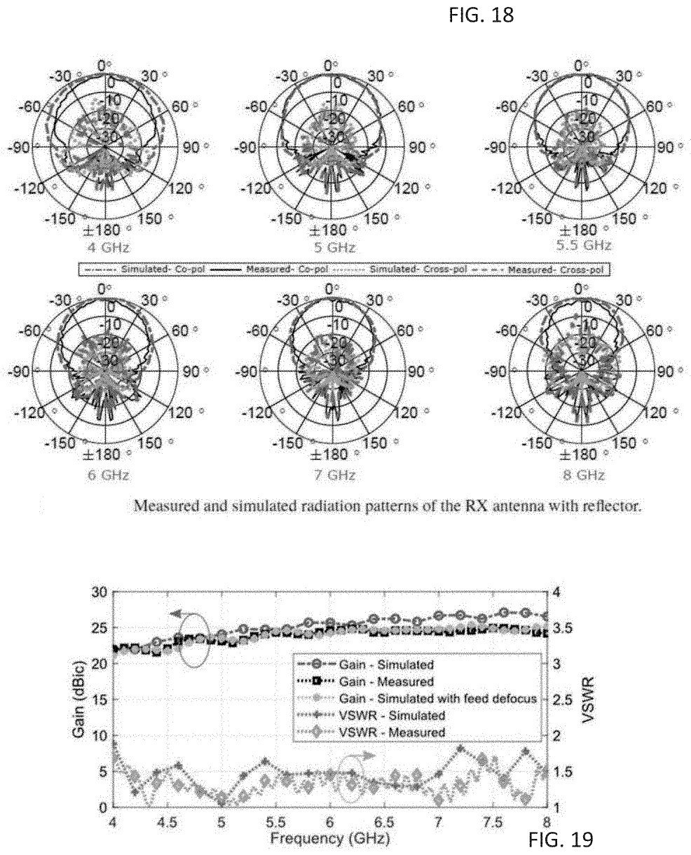

In one example implementation, a coaxial cavity antenna operating in its first higher order mode, TE11, is used as the feed for the reflector. The antenna is excited by four probes which are oriented and phased 90° to each other to achieve CP operation. The antenna in this particular example has a height of 5.06 cm, outer and inner conductor diameters of 4.62 cm and 1 cm, respectively. These physical parameters can be selected, such as a compromise between impedance match and the far field performance over the bandwidth. The phase center of the antenna is stable with <5% variation for CP. Additionally, the antenna has symmetric radiation patterns with axial ratio <3 dB for θ=±30°, VSWR <2, and gain >6 dBic over a 4 to 8 GHz operating frequency band. The impedance match of the antenna is less impacted by the presence of another antenna, and the reflector mounted behind it (see FIG. 15). However, the reflector has increased the gain of the RX at frequencies where the reflected fields from the reflector add constructively in the far field. Similarly, an increase in the cross-pol level of the RX is noticed in the presence of the reflector behind the antenna. The gain, and radiation patterns of the antenna with and without reflector are shown in FIG. 16, FIG. 17, and FIG. 18, respectively. Nonetheless, these deteriorations in the far field are not significant for some particular applications.

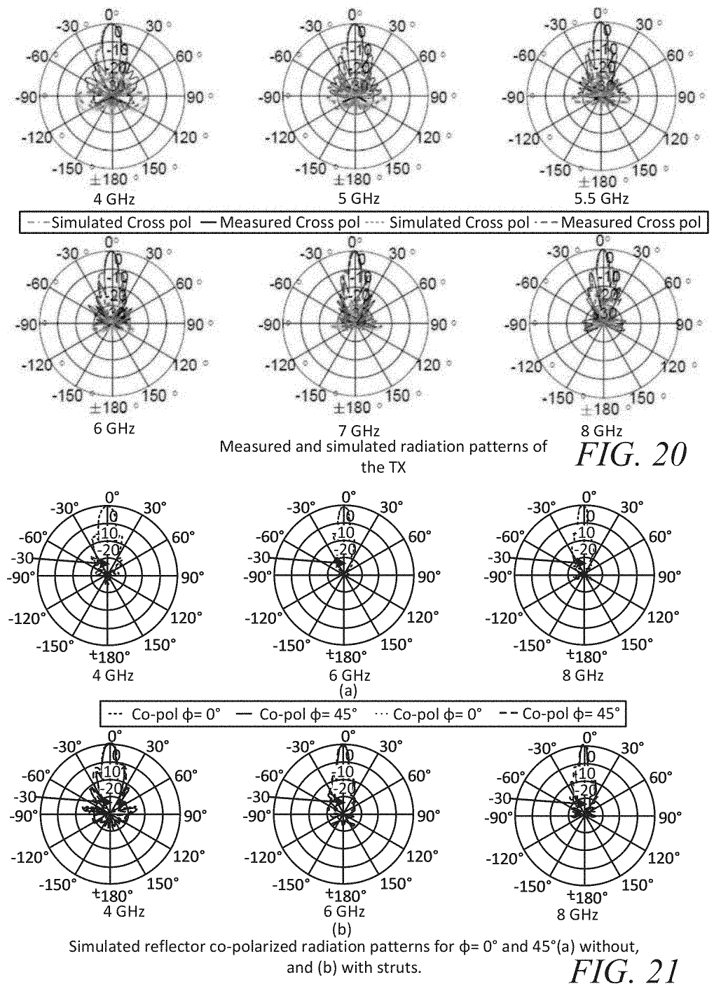

In one particular implementation, the existing axis-symmetric parabolic reflector with F/D=0.49, and diameter=40 cm is employed in an example STAR antenna system (see FIG. 1). The feed and the RX antennas can be supported using a conventional four struts approach, such as described in S. K. Sharma, S. Rao, and L. Shafai, Handbook of reflector antennas and feed systems volume I: theory and design of reflectors. Artech House, 2013. 12, 58, 70, 99, 108, 110. This mount provides extra sturdiness in comparison to a single- and three-struts approach and help maintain the symmetry, which is preferred for high isolation. The struts in this particular implementation are constructed as 1 cm outer diameter hollow cylindrical tubes, therefore, aiding the routing of RF cables to the reflector backside through it. A maximum drop of 1.16 dB (@ 6.8 GHz) in gain is observed over the band with the struts and the RX antenna mounted behind the TX feed antenna, which indicates that its influence is minimal. The quasi-static reflector antenna has gain >20 dBic, VSWR <2, and maximum aperture efficiency of 70% over the operating frequencies, 4-8 GHz, as shown in FIG. 19. The drop in the measured gain is primarily due to the defocus and slight offset of the feed from the center of the parabola. Hence, good agreement between measurement and simulation can be achieved by incorporating a focal point offset of 1.5 cm in z-axis, 0.3 cm and 0.8 cm in x- and y-axis, respectively, as illustrated in FIG. 19. The antenna, in this implementation, has side lobe level (SLL)<−10 dB over the operating frequency band, as shown in FIG. 20. The influence of the struts (oriented at 45°) on SLL at ϕ=45° is seen in FIG. 21. Note that this impact can be minimized by using polygonal, dielectric or corrugated struts.

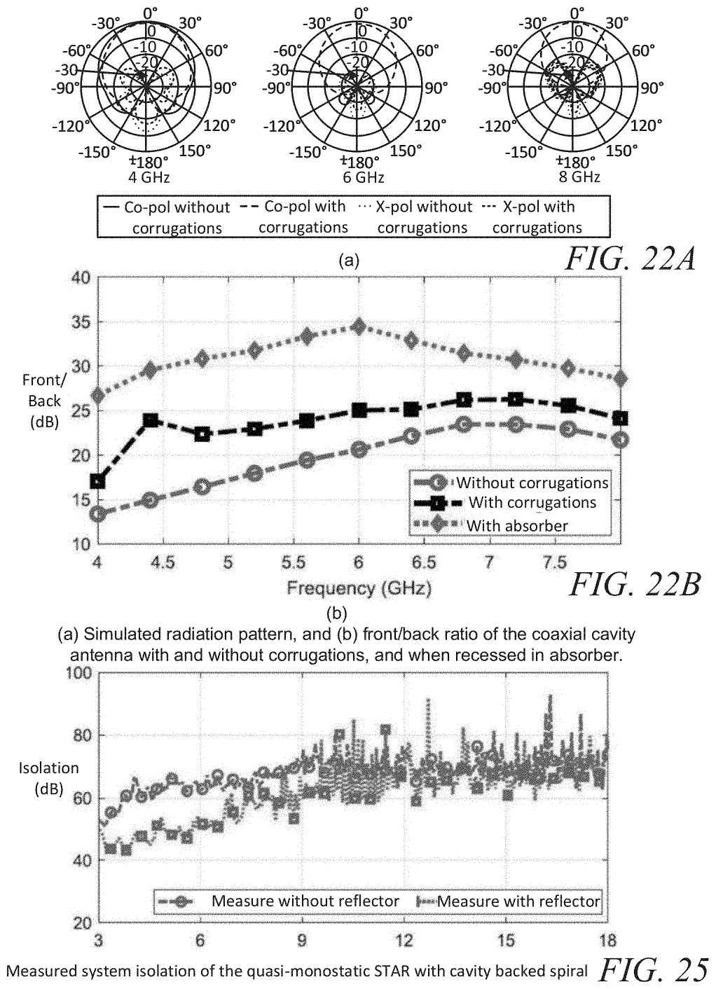

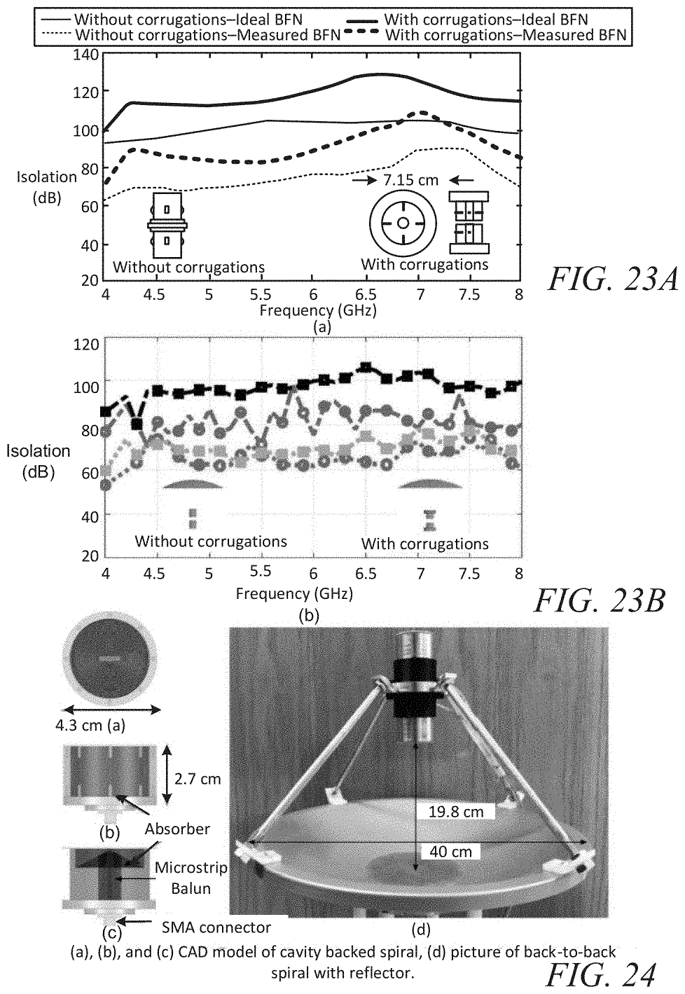

Radiation from the back lobe is the primary source of coupling in the proposed configuration. In some implementations, reducing the mutual coupling is desired since the lower the coupling the greater the robustness of the system isolation to the asymmetries and imbalances. Therefore, improving the F/B ratio of both antennas will reduce the coupling between the TX feed and RX, and thereby sensitivity of the system isolation to the BFN's imbalances. The F/B ratio can be increased using various techniques, such as, corrugations at the aperture, aperture matching, and recessing the antenna inside the absorber cavity. The metallic corrugations are quarter wavelength (at resonant frequency) chokes. High impedance offered by these surfaces reduces the diffracted fields from the aperture edges of the antenna, and thus, increasing the F/B ratio. Similarly, aperture matching minimizes diffracted fields radiated behind the antenna and improves the F/B ratio. When the antenna is recessed inside the absorber cavity, the losses in the absorber will help reduce the diffracted fields resulting a higher F/B ratio. However, the absorber may reduce the radiation efficiency of the antenna. The reduction in back lobe by 5-10 dB can be observed by comparing the radiation patterns of coaxial cavity antenna with and without corrugations, as shown in FIGS. 22A and 22B. In one particular example implementation, metallic corrugations of depth 1.87 cm (λ_{4GHz}/4), with four slots, resulting in a total diameter of 7.15 cm are used. It should be noted that the resulting feed size with corrugations is smaller than the size of the supporting structure for the struts used (see FIG. 1). Similarly, improvement in F/B ratio can be achieved by recessing the RX antenna inside the absorber as shown in FIG. 22B. A numerical absorber with ϵᵣ=1−j2.7, and μr=1−j2.7 is used for the study shown in FIG. 22. Further, the reduction in the back lobe in this particular example directly corresponds to the reduction in the mutual coupling, and hence, will result in increased system isolation. The lower mutual coupling will improve the tolerance of the system isolation to the imbalances as illustrated in FIGS. 23A and 23B.

In one particular example, isolation >60 dB over an octave bandwidth (4-8 GHz) is demonstrated in a quasi-monostatic STAR antenna configuration using coaxial cavity antennas as a feed and RX. An operation bandwidth over which high isolation can be achieved is mainly limited by the impedance bandwidth and far-field performance of the antenna employed, and not by the approach. Hence, the bandwidth of the proposed approach can be extended by employing a wideband radiator such as dual polarized quad ridge horn or a cavity-backed spiral as reflector feed and RX antenna (see FIG. 24). The number of components (180° and 90° hybrids) required in the BFN can be reduced significantly by employing a CP antenna, such as, cavity backed two-arm spirals as the feed and RX. Therefore, to demonstrate wideband operation with high isolation, two, cavity backed, absorber loaded two-arm Archimedean spirals operating from 3-18 GHz can be provided. A 4.3 cm spiral with 10 turns with equal metal to slot ratio and fabricated on a Taconic TLY 5 substrate with ϵᵣ=2.2, and tan δ=0.0009. A 2.7 cm tall metallic cavity loaded with absorber backs the aperture. The antenna, in this example, has VSWR <1.55, and AR<3 dB for θ=±30°, when fed by a microstrip balun.

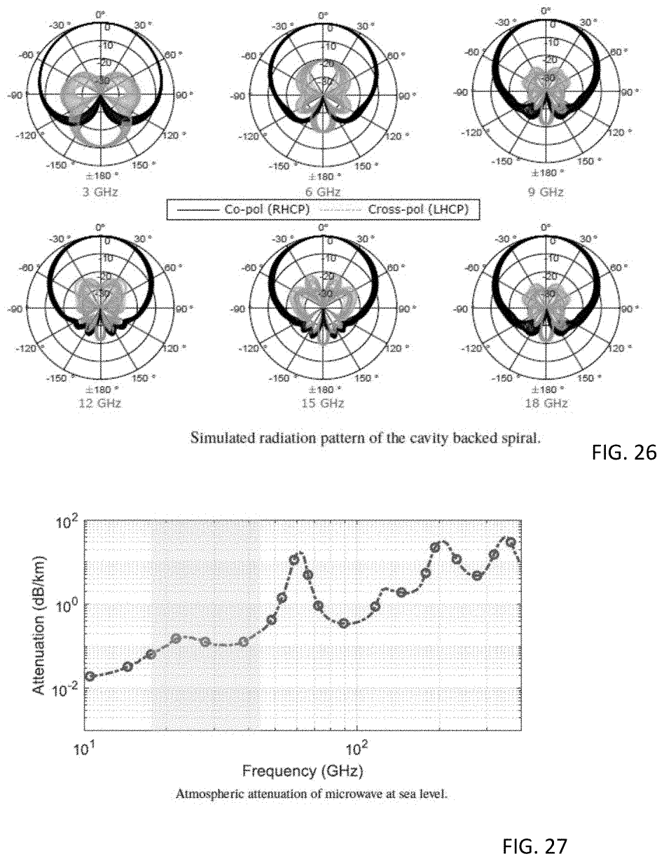

In one example implementation, a system isolation of 61 dB (average) can be achieved over 6:1 bandwidth when the spiral antenna is used in the proposed configuration, as shown in the FIG. 25. The high isolation achieved is mainly due to the low cross-pol and high F/B ratio of the spiral antenna (see FIG. 26). Hence, any feed with good axial ratio and low back lobes can be employed in the proposed configuration to realize high isolation wideband quasi-monostatic STAR system. Note that the reflector antenna with the spiral feed supports only the single polarization operation, in contrast to the reflector fed by the coaxial cavity antenna, which facilitates simultaneous dual polarization.

Various example implementations of a quasi-monostatic STAR antenna system are presented. Radiation properties of the feed and RX antennas, specifically, F/B ratio and cross-pol level can be important to achieve high isolation. The antennas can be operated in CP to achieve additional improvement in isolation. The approach is less sensitive to the asymmetries in the antenna geometry and the BFN. Average measured isolation of 61 dB using COTS components demonstrates that implementations of the proposed STAR antenna system can be practically realized with high system isolation. Further, in some implementations, the system can maintain isolation >50 dB even in case of deformation to the reflector surface, which may happen over time. Known techniques to improve the F/B ratio of the feed and thereby system isolation are also provided. Furthermore, it is shown that the operation bandwidth can be improved to more than an octave while maintaining high isolation, 61 dB (average), by using wideband cavity backed spiral antennas. The designed system, in one example, with coaxial cavity antenna has gain >20 dBic and >7 dBic for the TX and RX, respectively, and VSWR <2 over an octave bandwidth (4-8 GHz). In this implementation, the RX has wider beam compared to the TX due to the difference in the effective aperture sizes. This difference in directivity and patterns can be used as advantage in certain applications where a wide field of view for a sensor is desired and high gain beam is preferred for the TX.

Interest in frequencies, K-band and above is on the rise among both civilian applications, and in defense and aerospace areas. The former is driven by communication technologies such as proposed fifth generation wireless networks and automotive radars, due to large available instantaneous bandwidth, and better range and velocity resolution, respectively. Similarly, mm-Wave has the unexplored potential for EW and S, and signals intelligence (SIGINT). Additionally, antennas, feeding networks, and passive components are physically small. Hence, these could be efficiently housed inside cars and airborne vehicles like UAVs. Further, the current capabilities of additive manufacturing foster the design and fabrication of mm-Wave components.

Despite its benefits, implementing a STAR antenna system in mm-Wave frequencies is even more challenging. First, the signals will undergo greater path loss as given by Pathloss=20 log₁₀ (4πd/λ). Secondly, the atmospheric absorption of the waves is higher as depicted in FIG. 27. Hence, implementations may be designed with high gain antennas such as reflectors. In one implementation, for example, in-band full-duplex configuration can be used. However, the inner conductor of the coaxial cavity becomes small, (e.g., 2 mm) which can be mechanically feeble to self-support the feed. The availability of the COTS circulators covering the full 18-45 GHz frequency band is meager, and the system isolation will have increased sensitivity towards imbalances and asymmetries. Contrarily, in other implementations, the quasi-monostatic approach is another favorable option. However, the reflector topology used for realizing a STAR antenna system such as described above may require the feed to be placed at the focus of the axis-symmetric reflector. Thus, the TX path will have greater attenuation and routing of waveguides, desired for high power, can be cumbersome and contribute to reflector blockage. Therefore, a dual reflector based quasi-monostatic configuration, which addresses the challenges mentioned above, can also be provided.

Conventionally, Cassegrain and Gregorian reflectors have primary and secondary dishes in the order of 100λ and 10λ in diameter, respectively. Hence, they are preferred for ground station, on board satellites, and radars. However, reflectors in the order of 166 cm (100λ_{18GHz}) is not desired for small UAVs and decoys platforms. Therefore, the research focuses on designing small size dual-reflectors of diameter 30 cm (12″) and 15 cm (6″) for in-band full-duplex antenna systems.

### STAR Topologies

### Example Approach I

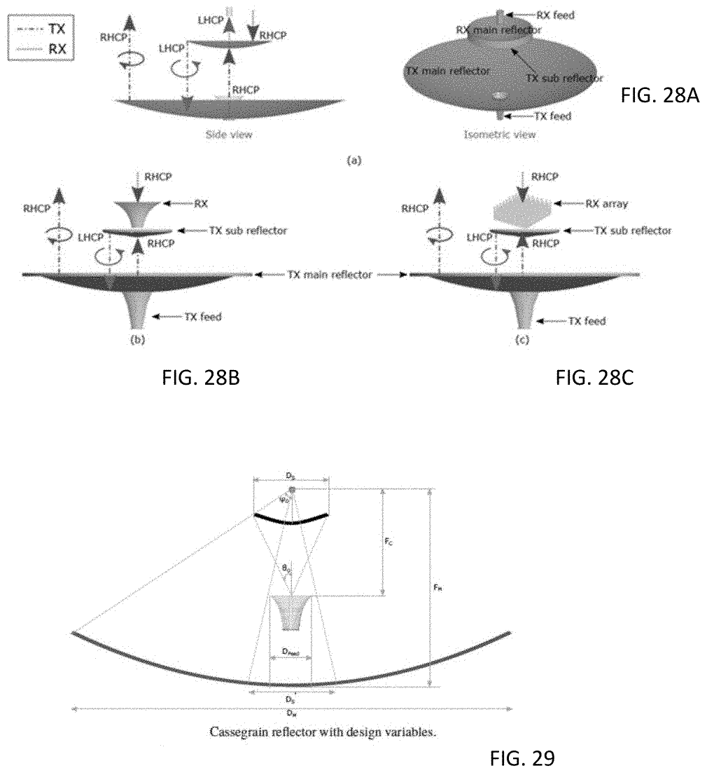

Example implementations of two STAR antenna topologies are provided herein. In a first approach, TX comprises a Cassegrain antenna, and the RX comprises a prime feed single reflector. Unlike a typical dual reflector, the unused backside of the secondary reflector can be utilized as the main dish for the RX, as illustrated in FIG. 28A. In a second example implementation, the STAR antenna system also employs a dual reflector for TX, whereas, the RX can be a QRH or tightly coupled array, mounted behind the secondary reflector, as shown in FIGS. 28B and 28C, respectively. Relatively small main dish size can deteriorate the far field performance due to the increased blockage, which is compounded by the difficulties in achieving required amplitude taper from the feed and the sub-reflector. This influence on radiation patterns can be minimized or at least reduced by modifying the profile of the QRH and shape of the secondary reflector while accounting for the feed's phase center variations as explained herein. Furthermore, a trade-off between the primary and secondary reflector diameter ratio, and its impact on far-field is provided. Further, the STAR antenna system functionality is provided with achievable system isolation >65 dB and far-field performance of the TX and RX antennas in some implementations.

Dual reflectors are one of the extensively researched and deployed antenna systems for high gain applications, because of benefits over front-fed or prime feed reflectors. Specifically, the location of the feed close to the source and the receiver, reduced spillover which minimizes the noise temperature, and its ability to provide equivalent focal length shorter than the physical/actual focal length leading to compact systems. Cassegrain and Gregorian are the two commonly used configurations. However, the former is preferred due to the proximity of the sub-reflector and the feed to the main dish, which results in smaller overall system volume. FIG. 29 depicts the arrangement of a Cassegrain reflector antenna with primary design parameters. These parameters are broadly classified as independent and dependent variables and are mainly decided by the far field requirements and the mechanical feasibility of the system. Therefore, a dual reflector antenna can be designed employing two principal approaches to result in the maximum aperture efficiency or gain, while minimizing the spillover and blockage loss.

In a first procedure, diameter of the main reflector, DM, is decided, independently, according to the desired antenna gain. Next, the size of the secondary dish, DS, is computed for the least blockage using Equation (1). Consequently, the feed is designed to provide the 10 dB taper at the edges of the sub-reflector, while satisfying the minimum blockage condition. This condition is achieved by maintaining the feed diameter DFeed and its shadow smaller than that of the secondary reflector, as illustrated in FIG. 29 and given by Equation (2).

$$\begin{matrix}\frac{{D}_{S}}{{D}_{M}} = {[ \frac{{cos}^{4} ( {θ}_{0} / 2 )}{{( 4 π )}^{2} ( sin {ψ}_{0} )} E \frac{λ}{{D}_{M}} ]}^{1 / 5} & ( 1 ) \\ \frac{{F}_{C}}{{F}_{M}} \approx \frac{1}{2} \frac{k {D}_{Feed}^{2}}{{F}_{C} λ} \approx \frac{{D}_{Feed}}{{D}_{S}^{′}} & ( 2 )\end{matrix}$$

In the second approach, primary reflector and the feed are designed first according to the requirements, followed by the secondary dish for minimum blockage condition using Equation (3), where P is given by Equation (4) and C is distance between sub-reflector foci. Furthermore, a balance between blockage and diffraction loss is achieved by modifying the sub-reflector diameter for optimum or highest gain.

$$\begin{matrix}[ \frac{2 {F}_{m} sin ( {tan}^{- 1} ( {D}_{Feed} / 2 C ) )}{1 + cos ( {tan}^{- 1} ( {D}_{Feed} / 2 C ) )} ] = \frac{2 ( {F}_{Eff} / {D}_{M} ) P sin {ψ}_{0}}{1 + ( {F}_{Eff} / {D}_{M} ) cos {ψ}_{0}} & ( 3 ) \\ P = \frac{2 C ( {e}^{2} - 1 )}{2 {e}^{2}} & ( 4 )\end{matrix}$$

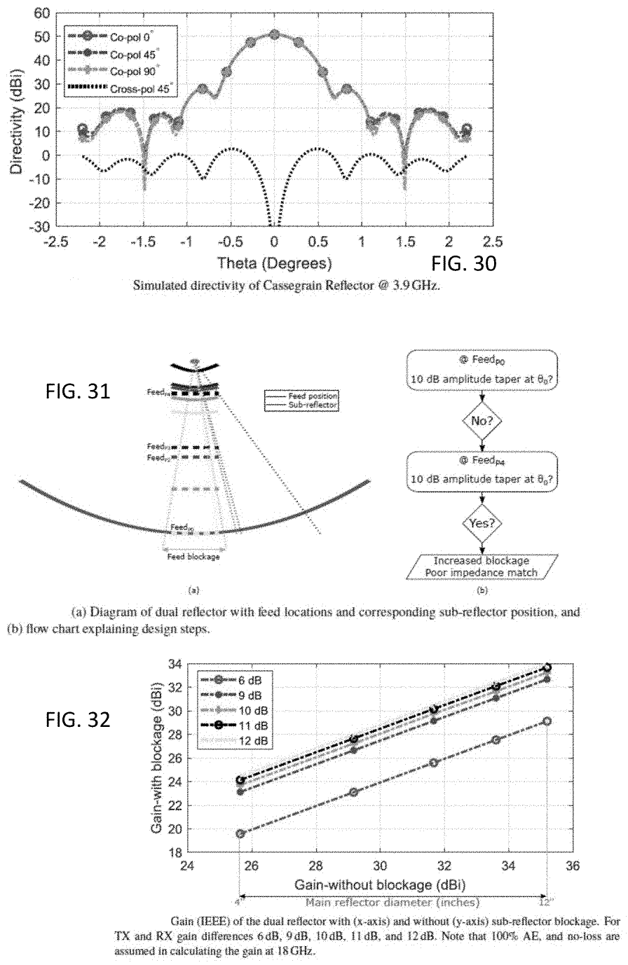

For example, in one implementation, a 10 m (130λ) diameter primary reflector of a Cassegrain antenna with F/D_{M}=0.3 and F_{Eff}/D_{M}=1.5 operating at 3.9 GHz is provided (see, e.g., T. A. Milligan, Modern antenna design. John Wiley & Sons, 2005. 12, 14, 38, 58, 69, 70, 108, 110, 111, 112, incorporated herein by reference). A secondary dish of diameter, DS=0.894 m (11.62λ), eccentricity, e, of hyperbola=1.5, is obtained for corrugated horn feed, D_{Feed}=0.415 m by using Equations (1) and (2). The feed has 10 dB taper illumination at the subtended angle, θ=18.9°. The resulting dual reflector antenna has directivity, 50.77 dBi, at 3.9 GHz, resulting in 71% aperture efficiency (AE), as shown in FIG. 30. The simulations are carried out in GRASP using geometrical optics (GO) and physical optics (PO) and accounting for the sub-reflector and feed blockage. These results indicate that greater AE, and high gain can be attained from a well-designed Cassegrain reflector antenna.

In various implementations, dual reflector antennas for compact airborne systems are provided. These platforms, in some cases, demand the overall system size to be in the order 12″ to 6″, which becomes a limitation to achieve maximum AE. That is, for the 12″ (18.2λ_{18GHz}) diameter main reflector, operating over 18-45 GHz, variation of F/D_{M} and F_{Eff}/D_{M} from 0.3 to 0.5, and from 0.75 to 0.25, respectively will result in sub-reflector diameter 1.47″ to 1.6″, which is obtained using Equations (3), (4), and minimum blockage condition. However, the size of the secondary dish, subtended angle, and the desired 10 dB amplitude taper illumination makes the design of feed nearly unrealistic for maximum AE and gain, as illustrated in FIG. 31. Contrarily, if approach II is followed, for 12″ main reflector and 1.7″ feed aperture the secondary dish should be of 7.9″ diameter (Equation (1)), which in some implementations can be impractical and result in high blockage loss. Therefore, achieving optimum AE and gain from a small dual reflector system, 9.1-18.2λ, can be nearly impossible. Hence, implementations including a Cassegrain antenna with acceptable radiation pattern quality and AE in the order of 40%, importantly, STAR functionality with high isolation and minimum difference between the TX and RX gains can be provided.

In one implementation, for example, a configuration comprises Cassegrain and prime feed reflector antennas for the TX and RX, as illustrated in FIG. 28A. The RHCP fields from the TX feed are reflected from the secondary reflector as LHCP in one implementation, which illuminates the primary dish. These incident waves will undergo polarization reversal due to the boundary condition and are re-radiated as RHCP. Analogously, the RHCP fields impinging on the receiving main reflector will flip the polarization such that all the power is transferred to the LHCP RX feed. Thereby, the STAR configuration operates in same sense of CP, without using any polarization diversity. The presence of RX within the space occupied by TX (in the x-y plane) makes the architecture quasi-monostatic.

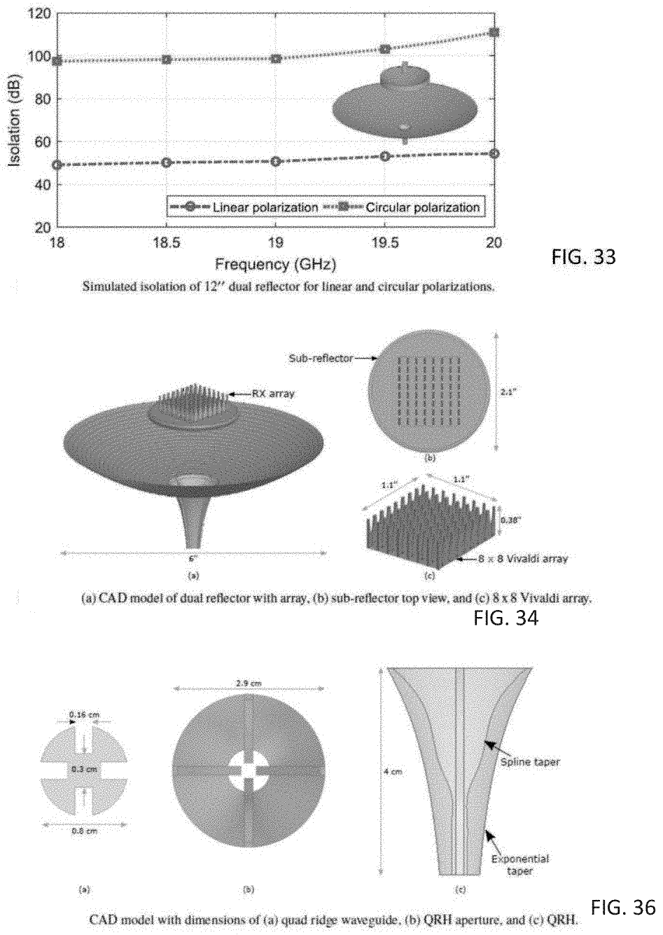

In this implementation, the power from the TX feed couples to RX feed through two paths. First, via cross-pol fields of both the antennas, as demonstrated in FIG. 28A. Hence, CP antennas with a low axial ratio (AR) will provide high isolation. Further, the presence of sub and main reflector of TX and RX, respectively, provides additional shielding. Contrarily, the spillover from these dishes will account for the second path of coupling. Therefore, minimizing or reducing the diffracted fields or increasing amplitude taper of the feeds can be beneficial for obtaining high isolation. Nonetheless, high isolation >45 dB and >90 dB can be achieved for LP and CP, in simulation with ideal BFN components as shown in FIG. 33. The radiation patterns and gain of both the TX and RX are shown in Fig.

Notice that the TX and RX have dissimilarity in their gain in this implementation, which is due to the difference in their radiating aperture areas. Therefore, increasing the sub-reflector diameter will minimize the inequality in the gains, however, at the expense of TX's AE as shown in the FIG. 32 and Table 6.1. Hence, the primary and secondary diameter ratio, 0.35, can be selected, which lead to a 9 dB gain difference compared to >16 dB of the configuration described above.

TABLE 6.1
Sub-and main reflector diameter ratio trade-off

| Gain Difference | Diameter | Blockage Loss | Aperture |
|---|---|---|---|
| (dB) @ 18 GHz | Ratio | (dB) | Efficiency |
| 6 | 0.5 | 6.06 | 24.76% |
| 9 | 0.35 | 2.51 | 55.98% |
| 10 | 0.32 | 1.93 | 64% |
| 11 | 0.28 | 1.50 | 70.75% |
| 12 | 0.25 | 1.17 | 76.35% |

Further, reducing the main reflector diameter from 12″ to 6″ will deteriorate the far field and impedance performance of both the TX and RX. This degradation is due to the increased proximity and the interaction between the reflectors and feeds, and higher spillover. Hence, the approach is not suitable for the system size <12″ in some implementations.

### Example Approach II

The configuration depicted in FIGS. 28B and 28B are more appealing than the Approach I, in implementations where a high gain STAR antenna system needs to be accommodated inside small payloads, which are in the order of 6″ diameter, and it is necessary to minimize the difference in the TX and RX gain. In this architecture, the unused area behind the sub-reflector is utilized for mounting a single aperture antenna or a tightly coupled array. Thus, the configuration provides two benefits. One, the available area can be effectively utilized to achieve 100% AE, and thereby, maximize RX gain. Secondly, the construction of the antenna is simple, robust, and enables easy integration of a radome.

The coupling phenomenon is similar to that in a quasi-monostatic STAR described above, where the significant part of the SI comes from the back lobe of the RX and the cross-pol of the TX feed. However, the presence of metallic sub-reflector provides additional isolation. Additionally, part of the power couples through the side lobes of the receiving antenna, hence the array should be designed for low SLL.

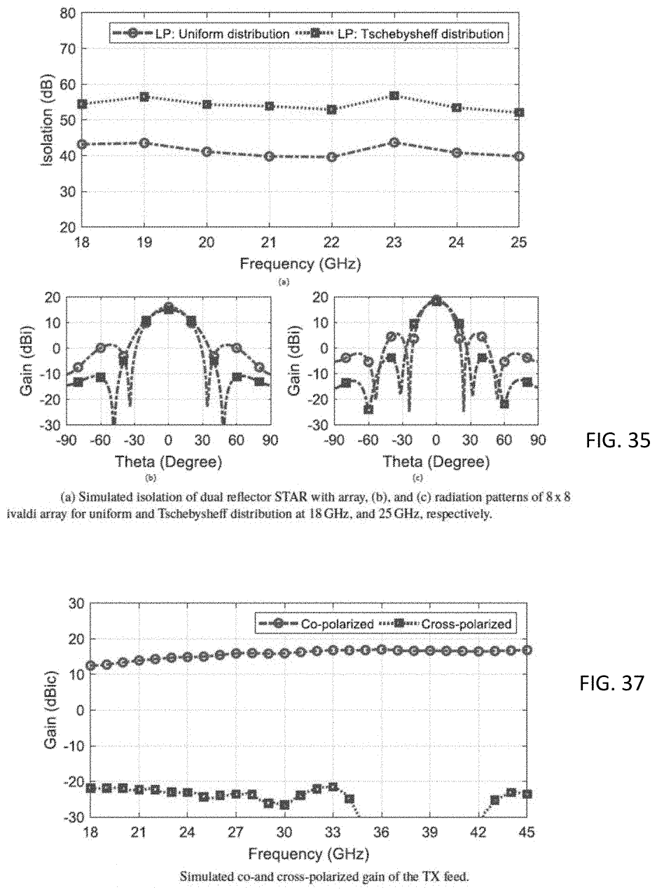

In one implementation, a 6″ Cassegrain reflector TX antenna and a tightly coupled Vivaldi RX array are designed as shown in the FIG. 34. The secondary dish is 2.1″ and can accommodate a maximum of 12×12 dual polarized Vivaldi elements, which can theoretically achieve 19.6 dBi gain at 18 GHz, thereby, reducing the TX and RX gain difference to 4.85 dB. A comparison of the number of elements, array size, and gain is summarized in Table 6.2. A single polarized 8×8 tightly coupled Vivaldi array with a dual reflector in proposed STAR configuration is simulated in FEKO and HFSS, for a proof of concept. Picture of the CAD models is shown in FIG. 34. System isolation >40 dB is achieved for LP, which could result in >60 dB for CP. Importantly, >10 dB improvement in isolation is achieved by exciting the elements with Tschebysheff distribution, which is primarily due to the reduction in the SLL, as depicted in FIG. 35. Note that 8×8 elements and single LP are selected due to the limitation of computational resources. Nonetheless, the configuration has the potential to provide high system isolation, minimize TX and RX gain, and facilitate multiple beams (simultaneously) for the receiving/sensing applications.

TABLE 6.2
Number of array element vs directivity difference - Approach II

| Number of | Array Size | Array Directivity | TX and RX Directivity |
|---|---|---|---|
| Elements | (cm) | (dB) | Difference |
| 8 | 3 | 16.1 | 8.37 dB |
| 10 | 3.75 | 18.03 | 6.44 dB |
| 12 | 4.5 | 19.61 | 4.85 dB |
| 14 | 5.25 | 20.93 | 3.48 dB |

The similar operation can also be achieved from a wideband QRH with ˜100% AE as an RX antenna. Specifically, a 2″ diameter aperture antenna can provide ˜19 dBi, which reduces the TX and RX gain difference to 6 dB. Additionally, the system will be simple to implement, practically.

### Feed Design

In some implementations, dual polarized conical QRH with single mode operation from 18-45 GHz can be used as a feed for the reflector. This antenna can be selected because of its bandwidth, high power handling, no loss, and ability to attain symmetric E- and H-plane patterns and greater AE. The symmetry in radiation patterns can be beneficial for achieving uniform illumination of sub-reflector and low cross-pol level in CP operation.

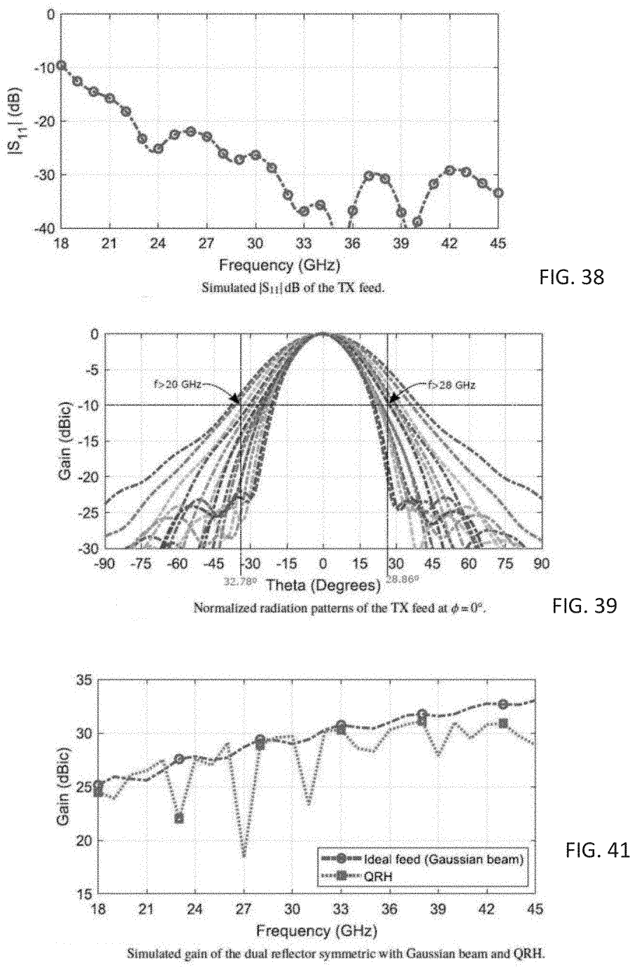

In one implementation, the cross-section of the circular quad-ridge waveguide and the horn aperture can be designed first. The former can be designed to provide modal purity over a frequency of interest, and the latter for desired amplitude taper while maintaining the blockage smaller than that of the sub-reflector. The dimensions of the resulting geometries are shown in FIGS. 36A and 36B. Furthermore, the taper of the ridges and the flare profile are chosen based on the parametric study, in HFSS, to achieve RL<10 dB, and patterns without the ripple and low SLL. The designed QRH has exponential tapered aperture and spline profile ridges (see FIG. 36C). The antenna has gain >11 dB, |S11|<−10 dB, as shown in FIG. 37 and FIG. 38, respectively. Also, amplitude taper >10 dB for θ=±32.8° and θ=±28.8° from 24 and 28 GHz, respectively, as illustrated in FIG. 39. The QRH can be fed using the turnstile junctions in some implementations.

### TX Design

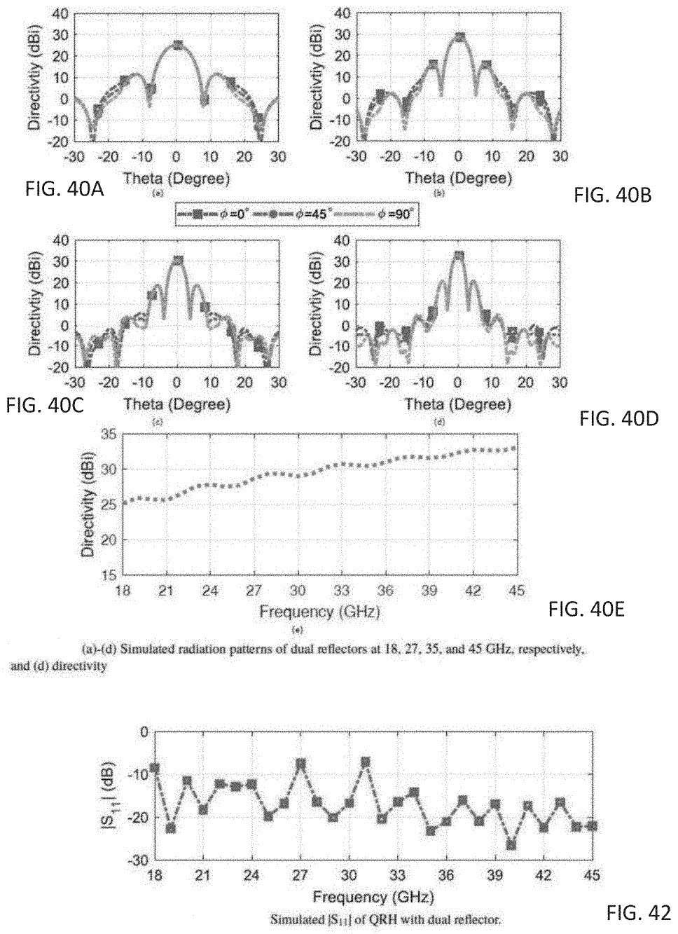

A 6″ Cassegrain reflector operates as the TX of one implementation of a STAR antenna system. The parameters of the antenna for this particular example are given in Table 6.3. In this design, the ratio, D_{M}/D_{S} is 0.31 which results in blockage loss 2.45 dB, computed using Equation (5). Therefore, the maximum attainable AE drops to 47.9%. Nonetheless, directivity >25 dBi, and SLL <12 dB is achieved when symmetric Gaussian beam is employed as the source, as shown in FIG. 40. These simulations are carried out in GRASP using GO and PO.

$$Blockage Loss = 20 log ( 1 - {[ \frac{{D}_{S}}{{D}_{M}} ]}^{2} ) ( dB ) \qquad ( 5 )$$

TABLE 6.3
Design parameters of dual reflector - Iteration I

| Parameter | Value |
|---|---|
| D_{M} | 6″ |
| F/D_{M} | 0.35 |
| Focal Distance | 2″ |
| D_{S} | 2.1″ |

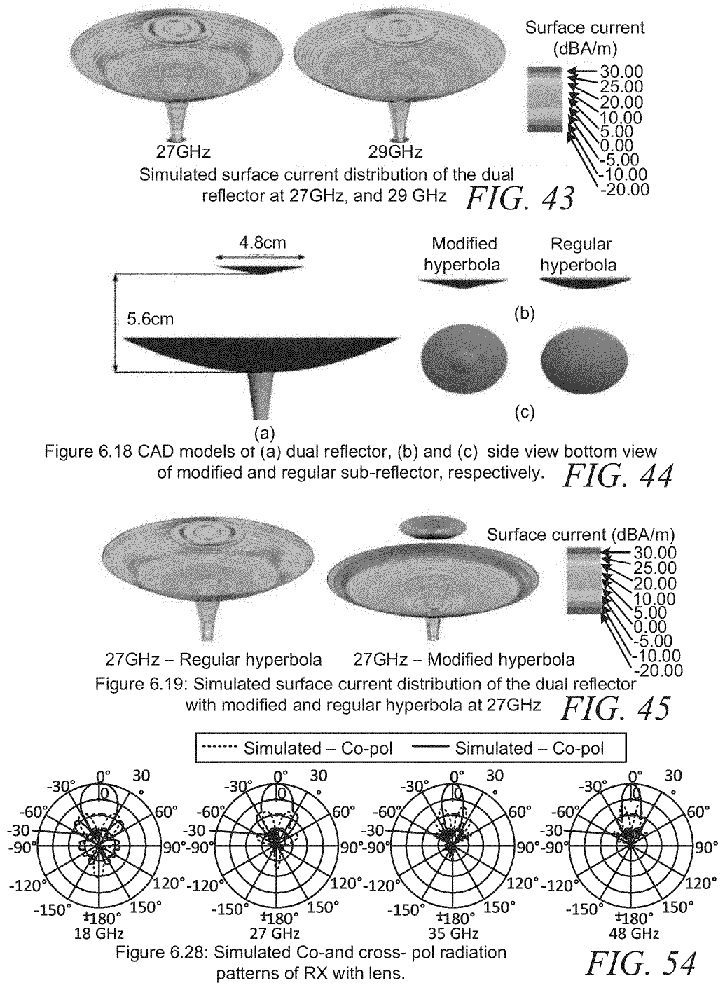

However, a prototype system utilizes the designed QRH as the feed. The realized gain deteriorates in comparison to the ideal case. Importantly, large drops are observed at frequencies 23, 27, and 31 GHz FIG. 41. Similar behavior is noticed in the |S11| response of the feed, as highlighted in FIG. 42, which indicates the presence of standing waves. Through full-wave analysis, it is found that the primary reasons for this trend are the interaction between the main, sub-reflector and feed, and offset in the phase center (PC) of the QRH from the focus. This interaction creates multiple bounces of the radiated fields, which results in under illumination of the main reflector, as illustrated in the FIG. 43 currents plots. Also, the distance between the apex of the sub-reflector and the feed aperture, 3.6 cm, corresponds to the frequency of the standing wave.

These problems can be minimized or at least reduced by accommodating one or more of the following three changes. The first is aimed to minimize the interaction. Increasing the F/D_{M} of the reflector will lead to higher focal length (Table 6.4), which translates to the larger space between the secondary dish and the feed. Hence, the new F/D_{M} is set to 0.5 corresponding to 5.6 cm between the apex of primary and sub-reflector FIG. 44. Note that F/D_{M} is limited to 0.5 to maintain the subtended angle relatively high such that the feed can satisfy 10 dB amplitude taper over a significant portion of operating frequencies.

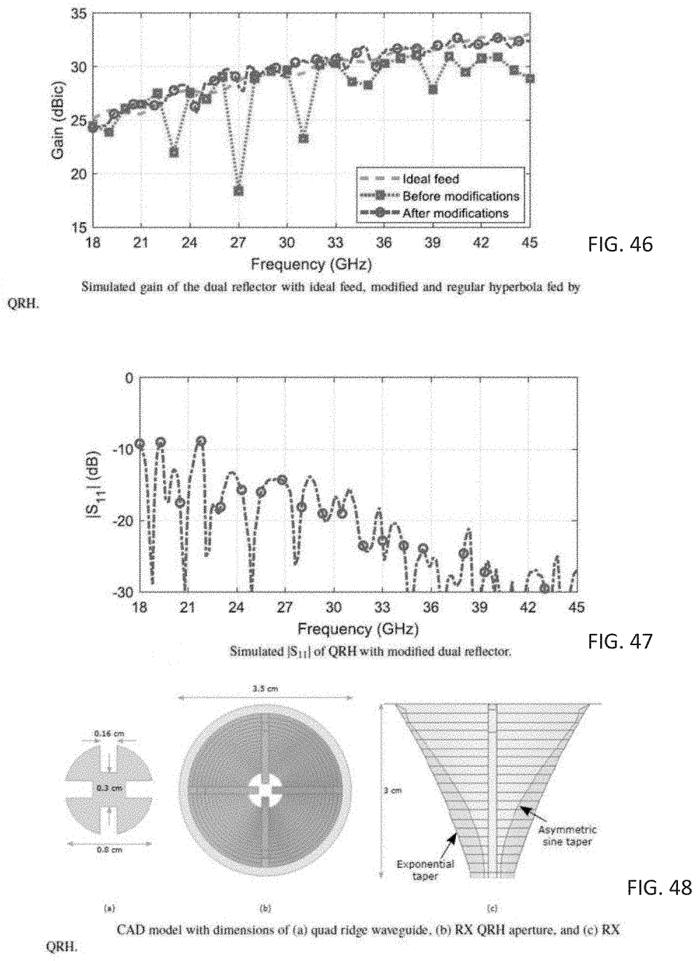

Second, the shape of the sub-reflector can be modified from its regular hyperbola to vary the phase of the reflected fields, thus, improving main dish illumination, as demonstrated in FIG. 45. These simulations can be performed in FEKO. Finally, the feed position can be altered to compensate for the change in phase center (PC). The PC variation is higher due to the flaring and the aperture size of the horn. Hence, it can be cumbersome to compensate over 2.5:1 frequency bandwidth by adjusting the antenna position. Nonetheless, a significant reduction in the ripples has been observed post modifications, as shown in FIG. 46. Further, the impedance match of the feed also reciprocates the similar trend (see FIG. 47). The radiation patterns of the TX are shown in Fig. The dimensions of the final design are listed in Table 6.4.

TABLE 6.4
Design parameters of dual reflector - Iteration II

| Parameter | Value |
|---|---|
| D_{M} | 6″ |
| F/D_{M} | 0.5 |
| Focal Distance | 2.9″ |
| D_{S} | 1.89″ |

### RX Design

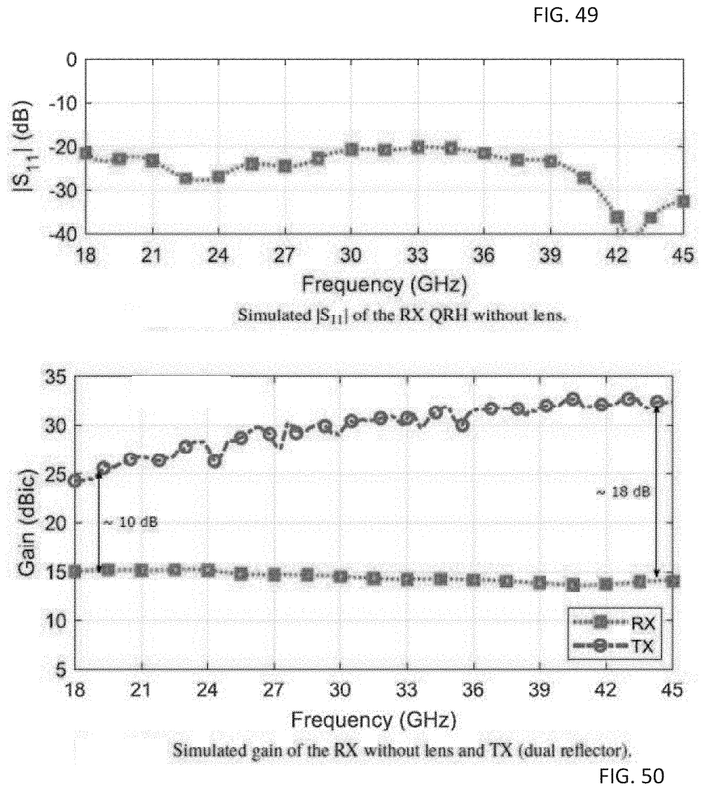

The receiving QRH can be designed to meet two goals. First, to minimize the TX and RX gain difference. Second, to contain the profile of the RX antenna within the sub-reflector size while keeping low height. A circular quad ridge waveguide is employed to excite the RX. Further, the aperture diameter is selected as 3.5 cm to cover the maximum available area behind the sub-reflector. The profile of the fare and ridges are modified to low |S11| and the SLL. The resulting antenna has an exponential taper for aperture and asymmetric sine taper for the rides, as shown in FIG. 48. The QRH has |S11|<−20 dB, gain 15±1.2 dB over the operational band shown in the FIG. 49, and FIG. 50, respectively. Thus, the difference in TX and RX gain is 10 dB, at 18 GHz, which is satisfactory. However, the margin increases to 18 dB at 45 GHz (see FIG. 50), mainly due to the reduction in AE of the horn. Hence, for some applications, the antenna gain can be improved.

The wide aperture (5.25λ_{45GHz}) and the flare angle are the causes for deterioration in the AE. Loading the horn aperture with a dielectric (c >1) will cause the incident fields to refract and in collimating the beam, thereby, increase the directivity. These antennas are referred to as lens corrected horns, which can be implemented in various ways. For example, four types are mentioned in A. D. Olver and P. J. Clarricoats, Microwave horns and feeds. IET, 1994, vol. 39. 58, 69, 127, 128, which is incorporated by reference herein, where shape and permittivity of the dielectric play the critical role.

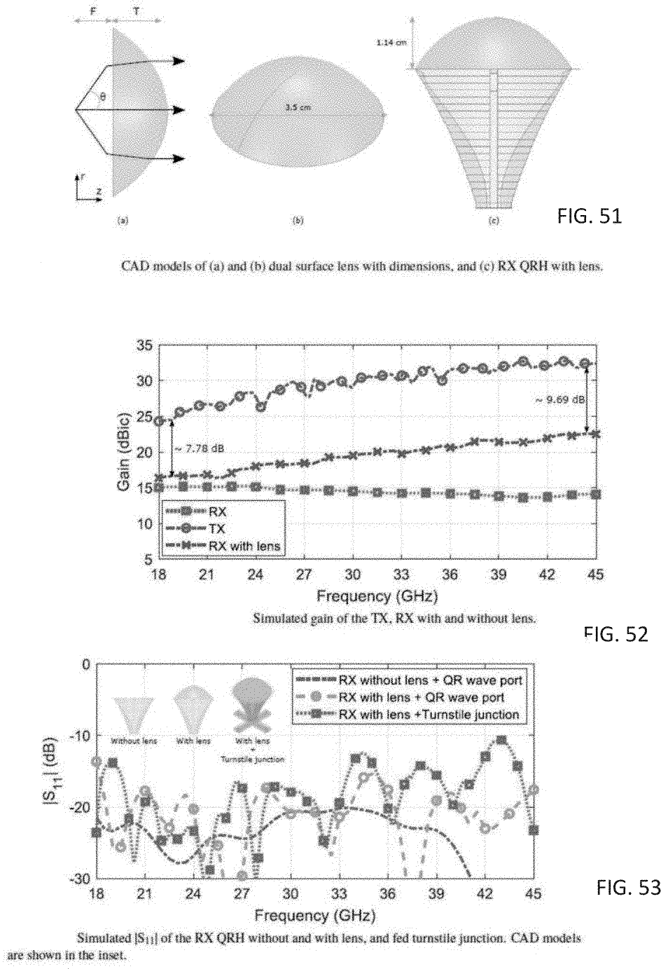

Type 3 lens or dual surface lens is one of the commonly used approaches, because of the easy integration with a horn. In these lens types, the fields undergo refraction at two faces as shown in FIG. 51. The design equations are given by Equations (6)-(9). Hence, the permittivity of the lens is a design trade-off, that is, higher the permittivity greater will be the mismatch between the waves inside the horn and the free space. Therefore, a lens of diameter 3.5 cm (same as the aperture) and height 1.14 cm, made of Teflon with ϵᵣ=2.1 can be designed. The gain of the resulting lens corrected horn in this example has an increase from 15 dB to 24 dB, at 45 GHz, which reduces the maximum difference between the TX and RX gain to 9.69 dB as shown in FIG. 52. Further, the horn is excited using turnstile junction fed by coaxial probes and the antenna has |S11|<10 dB over the operational band (see FIG. 53). Also, the radiation patterns of the RX are shown in FIG. 54.

$$\begin{matrix}r = \frac{F + ( n - 1 ) T + ( {n}^{2} - 1 ) F sec θ - FS tan θ}{( \frac{{n}^{2}}{sin θ} - S )} & ( 6 ) \\ z = ( r - F tan θ ) S & ( 7 ) \\ S = {[ {( \frac{n}{sin θ} )}^{2} - 1 ]}^{1 / 2} & ( 8 ) \\ \frac{T}{D} = [ {\{ 1 + \frac{1}{{( 2 F / D )}^{2}} \}}^{1 / 2} - 1 ] \frac{F / D}{n - 1} & ( 9 )\end{matrix}$$

### System Isolation

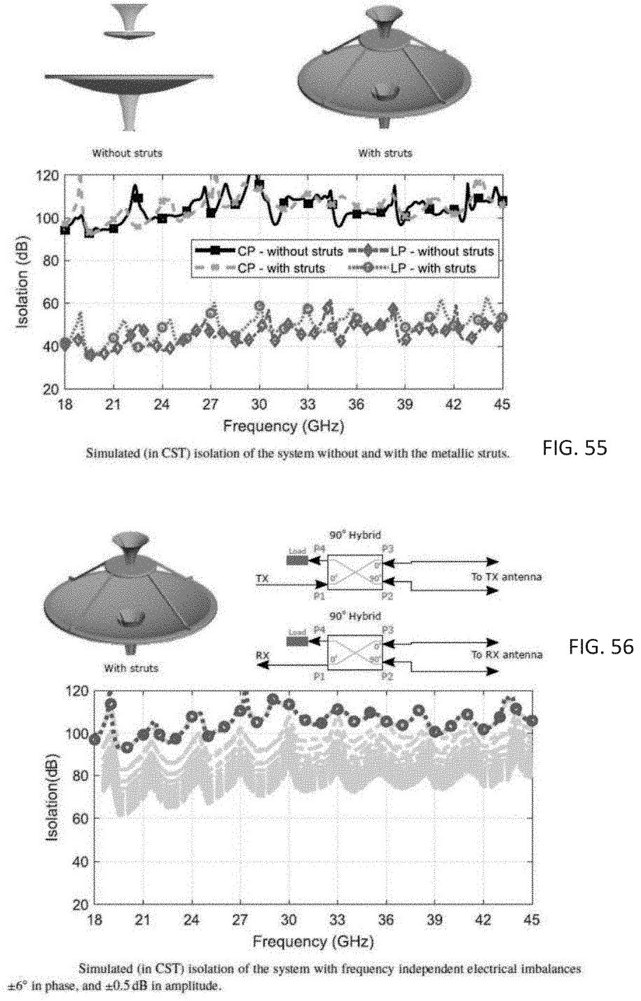

The coupling between the TX and RX is significantly through the back-lobe of the receiving antenna and the cross-pol of the TX feed, also, due to the scattering and spillover from the sub-reflector, as discussed above. The system isolation is >40 dB for LP which is governed by the inherent power coupling between the antennas. Furthermore, the isolation >80 dB is achieved when the TX and RX are CP, as illustrated in FIG. 55. This increase in isolation is due to the additional cancellation provided by the BFN, and the higher F/B ratio of the antennas. Also, the presence of struts has negligible influence on the system isolation because of the geometrical symmetry in the structure (see FIG. 55).

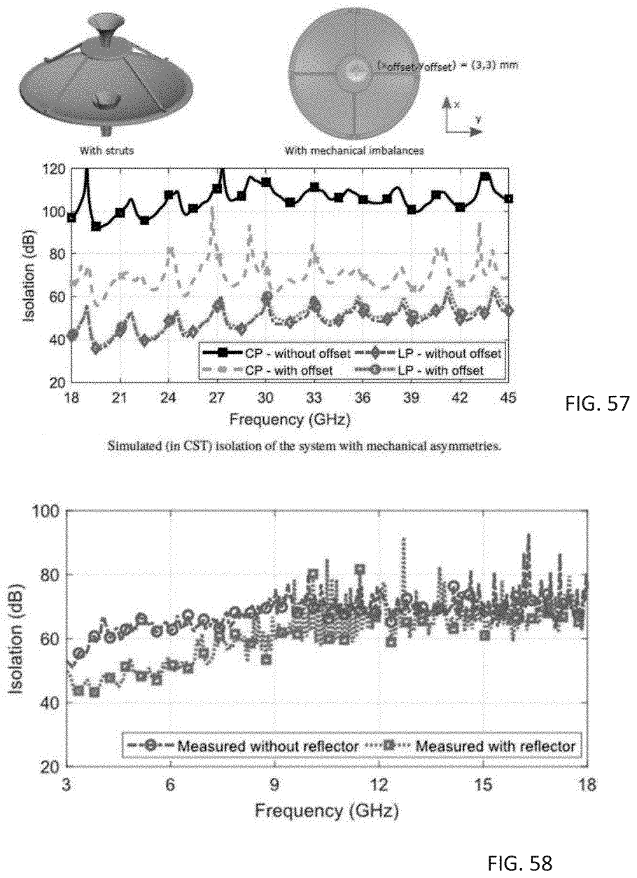

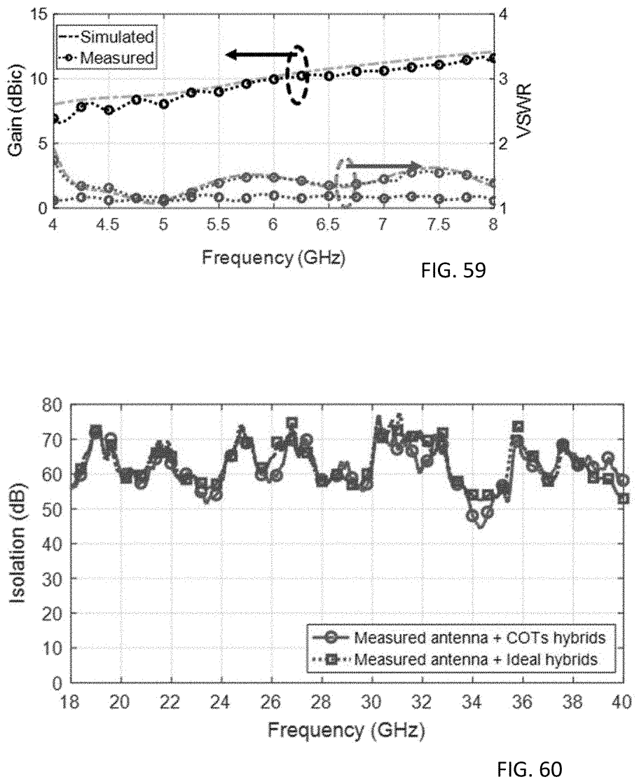

The configuration employs COTS 90° hybrids for realizing CP, and these components will have imbalances in amplitude and phase, which can influence system isolation. Hence, frequency independent asymmetry of ±6° in phase and ±0.5 dB in amplitude can be introduced in circuit simulator (AWR Microwave office) to analyze the impact on isolation. This imbalance deteriorates the attainable signal cancellation by 40 dB as illustrated in FIG. 56. However, the isolation is 30 dB higher than a monostatic system described above, which brings out the robustness of the configuration towards electrical asymmetries. Similarly, the isolation remains >60 dB when mechanical offset is incorporated into the structure, as shown in FIG. 57.

Furthermore, recessing the RX antenna inside the absorber cavity will result in lower SLL, as well as reduce the back-lobe level. Thereby, reducing the mutual coupling between the TX feed and the RX. Hence, the system can have higher tolerances towards the imbalances, that is, 10 dB higher isolation than the base case, as illustrated in FIG. 58.

STAR antenna systems are thus provided for mm-Wave. In one example, a new dual reflector antenna based in-band full-duplex configuration is provided. The approach provides inherent low coupling between the TX feed and the RX to achieve high isolation. Moreover, the antennas can be operated in CP to reduce the SI. Also, the steps of designing a conventional Cassegrain reflector are described. The impact of reducing the main dish diameter and DM/DS ratio on the far field are also provided. Three ways of realizing a STAR system comprising 12″ and 6″ dual reflector in conjunction with prime feed reflector, tightly coupled array and high gain QRH are provided, along with pros and cons of each approach. An in-band full-duplex 6″ Cassegrain reflector system can be implemented which has a gain >24 dB and >16 dB for the TX, and the RX, respectively. The effect of interaction between the sub-reflector and the TX feed on the far field and the measures to minimize this influence are further provided. Additionally, a lens corrected QRH is provided to improve the AE of RX, thus, reducing the difference in TX and RX gains. The system has isolation >60 dB for CP and >40 dB for LP, which can be potentially improved by 10 dB as demonstrated.

In various implementations, a quasi-monostatic STAR antenna system comprises a parabolic reflector antenna for transmission (TX) and a receiving (RX) antenna mounted back-to-back with the reflector feed. The physical size of the RX antenna can be comparable to or smaller than that of the TX feed, in order to prevent additional reflector blockage. To increase the system isolation both the TX feed and the RX antenna are CP. In one implementation, for example, to achieve same TX and RX polarization (i.e. no polarization multiplexing) the TX feed is LHCP and the RX antenna is RHCP. The LHCP fields from the TX feed undergo polarization reversal after bouncing back from the reflector. Thereby, the TX and RX operate in the same polarization, as illustrated in FIG. 1. This approach can also support simultaneous dual polarized operation if appropriate feed and RX antenna are used.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A quasi-monotonic simultaneous transmit and receive antenna comprising:
a parabolic reflector antenna for transmission (TX); and
a receiving (RX) antenna mounted back-to-back with the reflector feed.

2. The antenna of claim 1 wherein a physical size of the RX antenna is equal to or smaller than that of the TX feed.

3. The antenna of claim 1 wherein the TX feed and the RX antenna are circularly polarized (CP).

4. The antenna of claim 1 wherein the TX feed and the RX antenna are reverse circularly polarized.
